(19) United States
(12) Patent Application Publication
(10) Pub. No.: US 2011/0170449 A1
(43) Pub. Date: Jul. 14, 2011

(54) Frequency Selective SINR Regeneration

(75) Inventors: Yu Qian, Beijing (CN); David Astely, Bromma (SE); Yang Hu, Beijing (CN); Lei Wan, Beijing (CN)

(73) Assignee: Telefonaktiebolaget LM Ericsson, Stockholm (SE)

(21) Appl. No.: 13/061,768

(22) PCT Filed: Sep. 2, 2008
(86) PCT No.: PCT/SE08/50983

§ 371 Date: Mar. 2, 2011

(51) Int. Cl. H04W 24/00

(52) U.S. Cl. 370/252

(57) ABSTRACT

A method is performed by a device in a wireless network. The method includes receiving a transmission that includes a wideband channel quality indicator, determining a received signal power estimate for each frequency band of a frequency domain, and determining an average interference-plus-noise based on the wideband channel quality indicator and the received signal power estimate. The method further includes determining a signal-to-interference-plus-noise ratio estimate for each frequency band based on the average interference-plus-noise and the received signal power estimate, and performing a communicative operation based on the signal-to-interference-plus-noise ratio estimate.

### TECHNICAL FIELD

Implementations described herein relate generally to communication systems. More particularly, implementations described herein relate to a processing scheme for estimating channel conditions by a device in a communication system.

### BACKGROUND

In a communication system, such as a wireless communication system, devices may communicate with one another via a wireless communication link. For example, a wireless station and user equipment (UE) may communicate via wireless channels. A fundamental aspect to maintaining this communication link is link adaptation. For example, the wireless station communicates to the UE in a manner tailored to the channel conditions experienced by the UE. The wireless station is able to perform link adaptation based on receiving one or more channel quality indicators (CQIs) from the UE. For example, the UE may transmit a CQI report that includes one or more CQIs. The UE generates the CQI(s) based on its estimation of existing channel conditions. CQIs may also provide a basis for adapting other communicative operations, such as scheduling, etc.

In wideband communication systems (e.g., employing orthogonal frequency-division multiplexing (OFDM)), the bandwidth may be divided into several sub-bands, where each sub-band covers a number frequency units (e.g., sub-carriers in OFDM). In such a communication system, wideband CQI(s) may cover the whole bandwidth or a part of the whole bandwidth (e.g., one or more sub-bands). Based on this framework, when the frequency domain granularity of the CQI is narrow, the performance of link adaptation, scheduling, and other communicative operations (e.g., power control, timing control, handover, beamforming, etc.) may be improved compared to when the frequency domain granularity of the CQI is broader.

Problems exist, however, when implementing a narrower frequency domain granularity for CQI(s). For example, this typically results in more overhead. This is especially true in time division duplex (TDD) communication systems (e.g., long term evolution LTE-TDD or Worldwide Interoperability for Microwave Access (WiMax)) because of the asymmetric allocation of uplink and downlink timeslots. For example, where a high asymmetry exists (e.g., DL to UL is 9:1) and/or heavy data traffic exists, an UL CQI report channel may support only wideband CQI (e.g., the whole bandwidth or sub-band CQI(s) having a coarse frequency domain granularity). Another problem is that when the frequency domain granularity of the CQI(s) is narrow, the wireless station may take a longer period of time to update and/or adapt. As a result, the performance of the wireless station with respect to link adaptation, scheduling, and/or other communicative operations may be degraded.

While the existence of channel reciprocity in TDD communication systems is well known, channel reciprocity does not resolve all the issues related to link adaption, scheduling, and other communicative operations. For example, in a TDD communication system, the interference between uplink and downlink directions does not necessarily correlate at all (i.e., interference is not reciprocal).

### SUMMARY

It is an object to obviate at least some of the above disadvantages and to improve the operability of devices within a communication system.

According to one aspect, a method, performed in a wireless network by a first device that is communicatively coupled to a second device, may include receiving a first transmission that includes a wideband channel quality indicator associated with the second device, determining a received signal power estimate for each frequency band of the first transmission based on the first transmission or for each frequency band of a second transmission based on the received second transmission, determining an average interference-plus-noise based on the wideband channel quality indicator and the received signal power estimate; determining a signal-to-interference-plus-noise-ratio estimate for each frequency band based on the received signal power estimate and the average interference-plus-noise, and transmitting a third transmission based on the signal-to-interference-plus-noise ratio estimate for each frequency band.

According to another aspect, a device in a wireless environment may include one or more antennas and a processing system to receive, via the one or more antennas, a transmission that includes a wideband channel quality indicator associated with another device, calculate a received signal power estimate for each frequency band of a frequency domain, calculate an average interference-plus-noise based on the wideband channel quality indicator, calculate a signal-to-interference-plus-noise estimate for each frequency band, and perform a communicative operation based on the signal-to-interference-plus-noise estimate for each frequency band.

According to still another aspect, a computer-readable medium containing instructions executable by at least one processor of a device capable of receiving and transmitting, the computer-readable medium may include one or more instructions for receiving a transmission from another device, the transmission including a wideband channel quality indicator, one or more instructions for calculating a receiving signal power estimate for each frequency band of a frequency domain, one or more instructions for calculating an average interference-plus-noise based on the wideband channel quality indicator and the received signal power estimate, one or more instructions for calculating a signal-to-interference-plus-noise estimate for each frequency band based on the average interference-plus-noise, and one or more instructions for performing at least one of link adaptation or scheduling based on the calculated signal-to-interference-plus-noise estimate.

### BRIEF DESCRIPTION OF THE DRAWINGS

FIG. 1A is a diagram illustrating devices communicating with one another via a wireless communication link;

FIG. 1B is a diagram illustrating an exemplary implementation of the devices in FIG. 1A in which one of the devices is a UE and one is a wireless station;

FIG. 2A is a diagram illustrating exemplary components of the wireless station depicted in FIG. 1B;

FIG. 2B is a diagram illustrating an exemplary functional component for determining frequency selective signal-to-interference-plus-noise ratios (SINRs) of the wireless station depicted in FIGS. 1A and 1B;

FIGS. 3A-3C are diagrams illustrating exemplary components of the UE depicted in FIG. 1B;

FIG. 4 is a flow diagram illustrating an exemplary process for determining a wideband CQI;

FIG. 5 is a diagram illustrating an exemplary scenario in which a wideband CQI may be determined; and

FIG. 6 is a flow diagram illustrating an exemplary process for determining a signal-to-interference-plus noise ratio for an i-th frequency unit.

### DETAILED DESCRIPTION

The following detailed description refers to the accompanying drawings. The same reference numbers in different drawings may identify the same or similar elements. Also, the following description does not limit the invention.

The concepts described herein relate to a communication system. The communication system is intended to be broadly interpreted to include any type of wireless network, such as a cellular network and/or a mobile network (e.g., Global System for Mobile Communications (GSM), Long Term Evolution (LTE), Wideband Code Division Multiple Access (WCDMA), Ultra Mobile Broadband (UMB), Universal Mobile Telecommunications Systems (UMTS), ad hoc networks, High-Speed Packet Access (HSPA), etc.), and a non-cellular network (e.g., Worldwide Interoperability for Microwave Access (WiMax), etc.). In this regard, it will be appreciated that the concepts described may be implemented within a wide variety of communication systems. The communication system may include a time division duplex (TDD) communication system where channel reciprocity exists. The terms communication system and network may be used interchangeably throughout this description.

Embodiments described herein may provide that a device in a communication system may receive wideband CQI(s) to estimate frequency-selective signal-to-interference-plus-noise ratios (SINRs). For example, a device may estimate a SINR at a finer frequency level than a reported CQI. The SINR may be estimated with minimal overhead, yet improve the performance of link adaptation, scheduling, and/or other communicative operations, as well as overall system performance, such as throughput, etc.

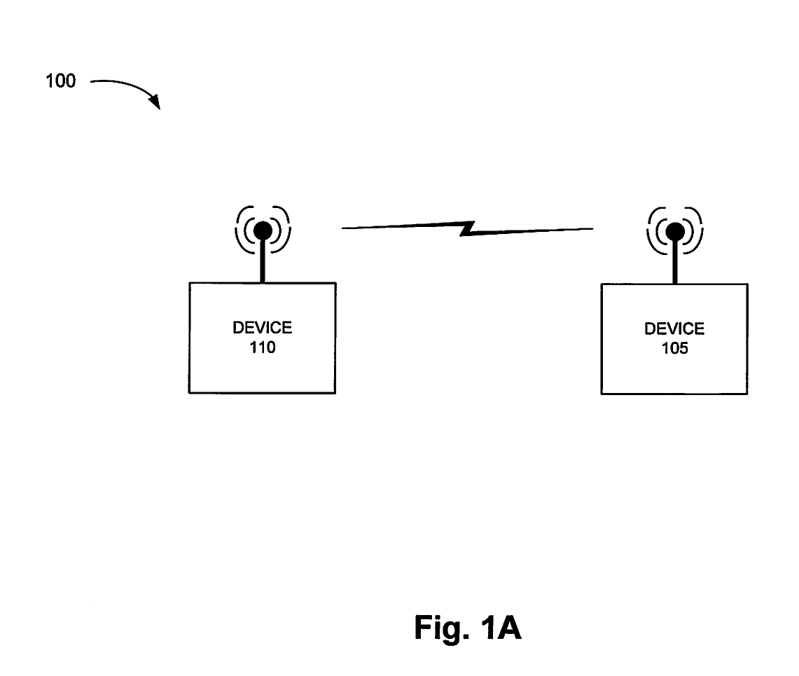

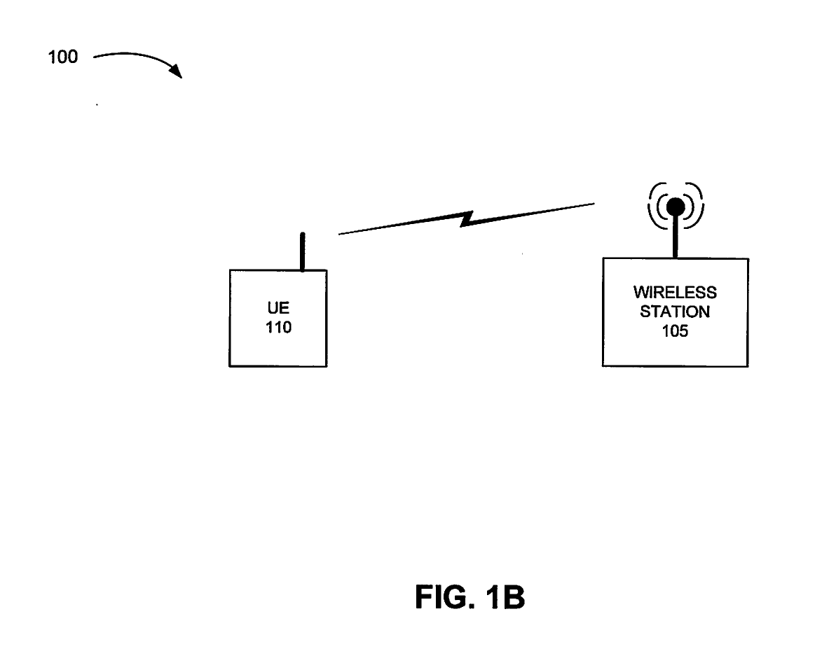

FIG. 1A is a diagram illustrating an exemplary communication system 100 in which the concepts described herein may be implemented. As illustrated, communication system 100 may include a device 105 and a device 110. A device may include, for example, a UE, a gateway, a base station, a relay, a repeater, a combination thereof, or another type of device (e.g., a satellite). The device may operate at layer 1, layer 2, and/or at a higher layer. As illustrated in FIG. 1A, the devices may be communicatively coupled. For example, devices 105 and 110 may be communicatively coupled via wireless communication links (e.g., radio, microwave, etc.).

Since the concepts described herein are applicable to a variety of devices in communication system 100, communication system 100 will be described based on the exemplary devices illustrated in FIG. 1B, where device 110 includes a UE and device 105 includes a wireless station. As illustrated in FIG. 1B, wireless station 105 and UE 110 may be communicatively coupled.

Wireless station 105 may include a device having communication capability. The term wireless station is intended to be broadly interpreted to include, for example, a device that may communicate with UE 110. For example, a wireless station may include a base station (BS), a base station transceiver (BTS) (e.g., in a GSM communication system), an eNodeB (e.g., in a LTE communication system), a Node B (e.g., in a UMTS communication system), an access point, or some other type of device.

UE 110 may include a device having communication capability. For example, UE 110 may include a telephone, a computer, a personal digital assistant (PDA), a gaming device, a music playing device, a video playing device, a web browser, a pager, a personal communication system (PCS) terminal, a mobile station, a fixed subscriber unit, a pervasive computing device, and/or some other type of communication device.

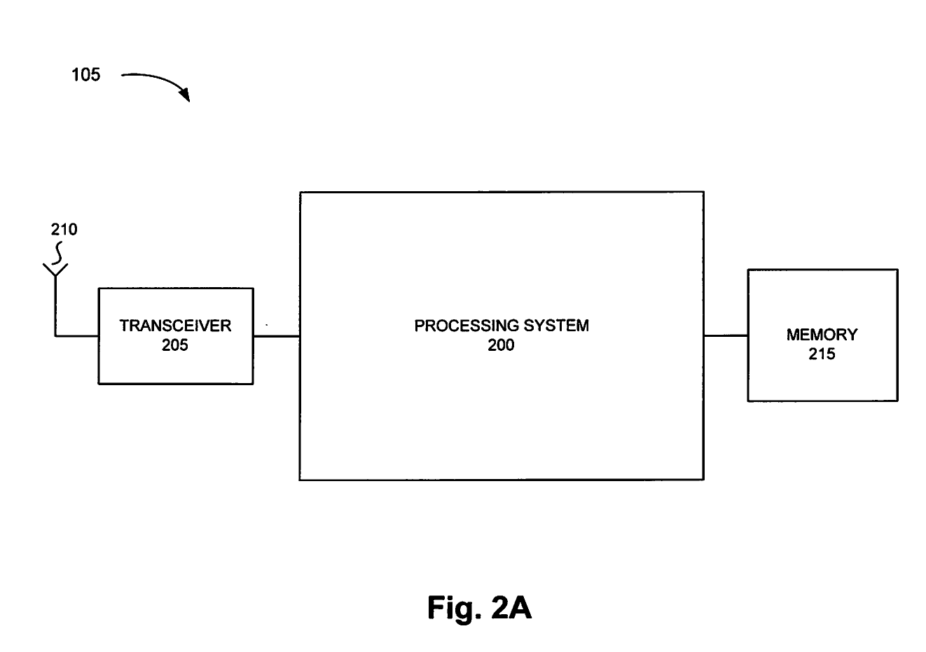

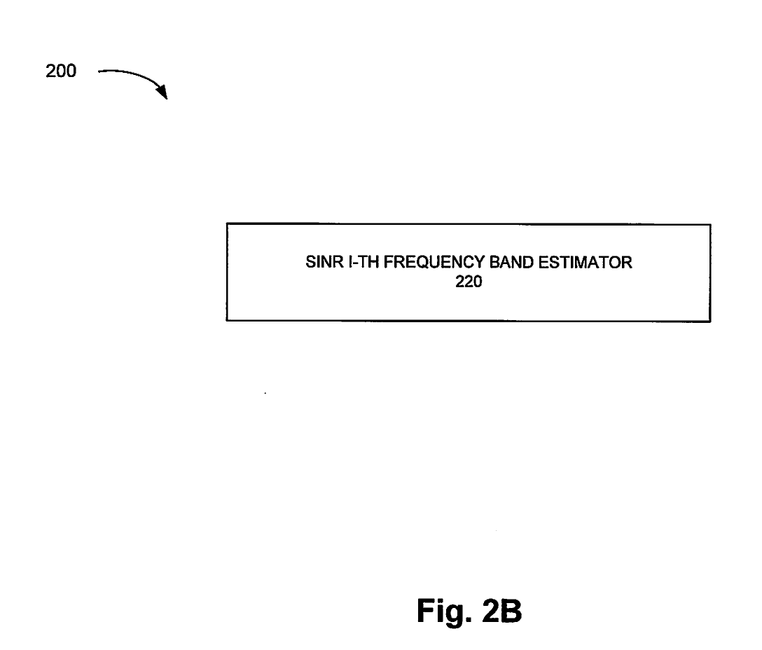

FIG. 2A is a diagram illustrating exemplary components of wireless station 105. As illustrated, wireless station may include a processing system 200, a transceiver 205, an antenna 210, and a memory 215. The term component is intended to be broadly interpreted to include, for example, hardware, software and hardware, firmware, and/or software.

Processing system 200 may include a component capable of interpreting and/or executing instructions. For example, processing system 200 may include a general-purpose processor, a microprocessor, a data processor, a co-processor, a network processor, an application specific integrated circuit (ASIC), a controller, a programmable logic device, a chipset, and/or a field programmable gate array (FPGA). Processing system 200 may control one or more other components of wireless station 105. Processing system 200 may be capable of performing various communication-related processing (e.g., signal processing, channel estimation, beamforming, power control, link adaptation, scheduling, etc.).

Transceiver 205 may include a component capable of transmitting and/or receiving information over wireless channels via antennas 210. For example, transceiver 205 may include a transmitter and a receiver. The transmitter may map symbols into a representation appropriate for the transmission medium or channel (e.g., a radio channel) and may couple the symbols to the transmission medium via antenna 210. The receiver may include, for example, a RAKE or a Generalized RAKE (G-RAKE) architecture. Transceiver 205 may be capable of performing various communicative processing (e.g., de/modulation, de/interleaving, equalizing, filtering, de/coding, amplifying, sampling, forward error correction (FEC), etc.). Antenna 210 may include a component capable of receiving information and transmitting information via wireless channels. Antenna 210 may include a multi-antenna system (e.g., a MIMO antenna system). Antenna 210 may provide one or more forms of diversity (e.g., spatial, pattern, or polarization).

Memory 215 may include a component capable of storing information (e.g., data and/or instructions). For example, memory 215 may include a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

Although FIG. 2A illustrates exemplary components of wireless station 105, in other implementations, wireless station 105 may include fewer, additional, and/or different components than those depicted in FIG. 2A. It will be appreciated that one or more components of wireless station 105 may be capable of performing one or more other operations associated with one or more other components of wireless station 105.

FIG. 2B is a diagram illustrating a SINR I-th Frequency Band Estimator (SINR I-th FBE) 220 capable of calculating frequency selective SINR(s) based on wideband CQI(s) or coarse frequency domain CQI(s). In one embodiment, SINR I-th FBE 220 may be implemented in processing system 200 of wireless station 105. However, it will be appreciated that SINR I-th FBE 220 may be implemented in connection with, for example, other components (e.g., transceiver 205), in combination with two or more components (e.g., processing system 200 and transceiver 205), or as an additional component to those previously described in FIG. 2A. The operations performed by the SINR I-th FBE 220 for calculating frequency selective SINR(s) will be described in greater detail below.

Although FIG. 2B illustrates an exemplary functional component, in other implementations, wireless station 105 may include additional and/or different components than those described in FIG. 2B. Additionally, or alternatively, the operations associated with the functional component may be performed in a distributed manner (e.g., in more than one device).

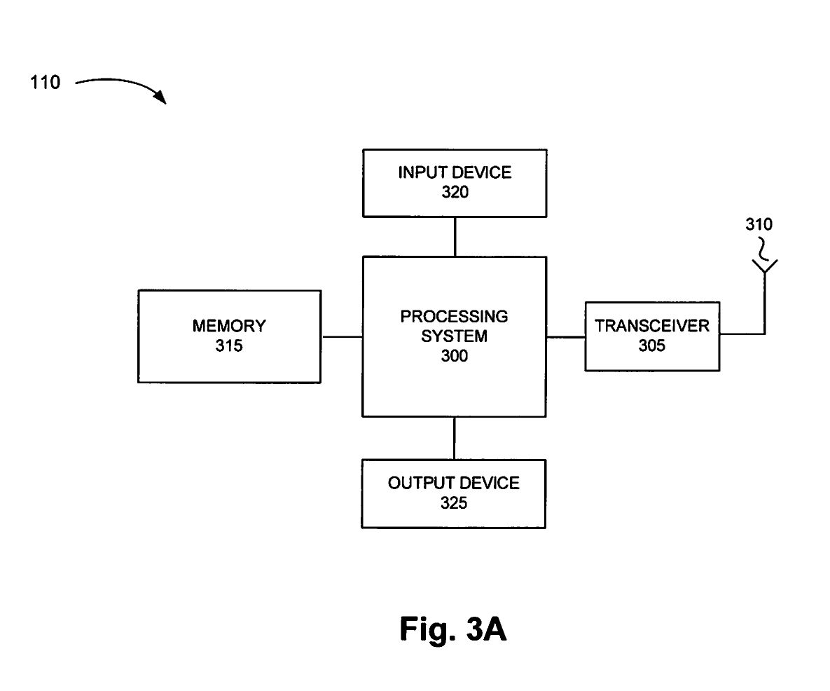

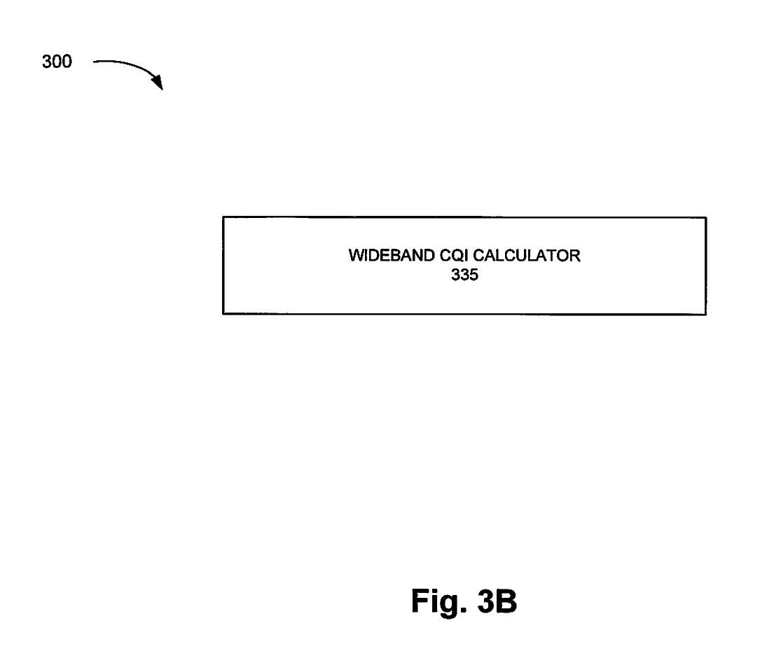

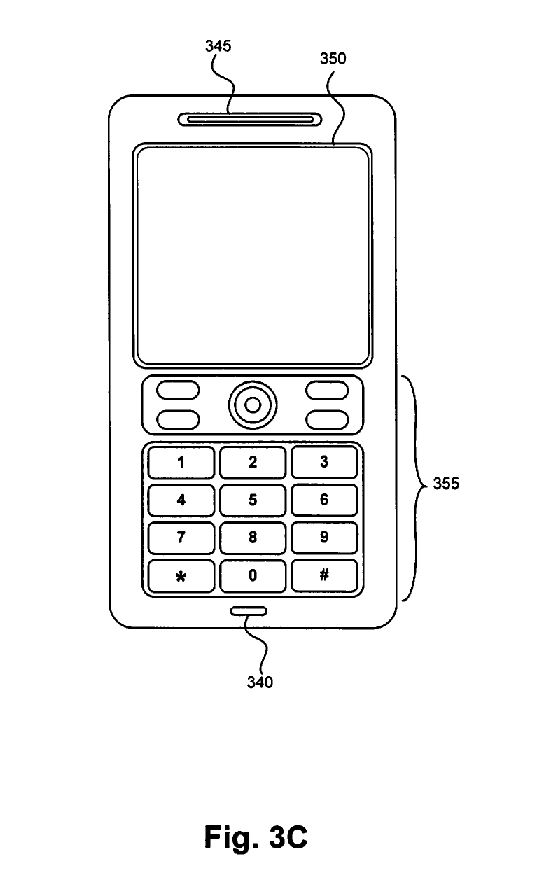

FIG. 3A is a diagram illustrating exemplary components of UE 110. As illustrated, UE 110 may include a processing system 300, a transceiver 305, an antenna 310, a memory 315, an input device 320, and an output device 325.

Processing system 300 may include a component capable of interpreting and/or executing instructions. For example, processing system 300 may include, a general-purpose processor, a microprocessor, a data processor, a co-processor, a network processor, an application specific integrated circuit (ASIC), a controller, a programmable logic device, a chipset, and/or a field programmable gate array (FPGA). Processing system 300 may control one or more other components of UE 110. Processing system 300 may be capable of performing various communicative processing (e.g., signal processing, channel estimation, power control, timing control, etc.).

Transceiver 305 may include a component capable of transmitting and/or receiving information over wireless channels via antennas 310. For example, transceiver 305 may include a transmitter and a receiver. Transceiver 305 may be capable of performing various communication-related processing (e.g., filtering, de/coding, de/modulation, etc.). Antenna 310 may include a component capable of receiving information and transmitting information via wireless channels. Antenna 310 may include a multi-antenna system (e.g., a MIMO antenna system).

Memory 315 may include a component capable of storing information (e.g., data and/or instructions). For example, memory 315 may include a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

Input device 320 may include a component capable of receiving an input from a user and/or another device. For example, input device 320 may include a keyboard, a keypad, a mouse, a button, a switch, a microphone, a display, and/or voice recognition logic.

Output device 325 may include a component capable of outputting information to a user and/or another device. For example, output device 325 may include a display, a speaker, one or more light emitting diodes (LEDs), a vibrator, and/or some other type of visual, auditory, and/or tactile output device.

Although FIG. 3A illustrates exemplary components of UE 110, in other implementations, UE 110 may include fewer, additional, and/or different components than those depicted in FIG. 3A. For example, UE 110 may include a hard disk or some other type of computer-readable medium along with a corresponding drive. The term “computer-readable medium,” as used herein, is intended to be broadly interpreted to include, for example, a physical or a logical storing device. It will be appreciated that one or more components of UE 110 may be capable of performing one or more other operations associated with one or more other components of UE 110.

FIG. 3B is a diagram illustrating a wideband CQI calculator 335 capable of determining a wideband CQI(s). In one embodiment, wideband CQI calculator 335 may be implemented in processing system 300. However, it will be appreciated that wideband CQI calculator 335 may be implemented in connection with, for example, other components (e.g., transceiver 305), in combination with two or more components (e.g., processing system 300 and transceiver 305), or as an additional component to those previously described in FIG. 3A. The operations performed by wideband CQI calculator 335 will be described in greater detail below.

FIG. 3C is a diagram illustrating an exemplary implementation of UE 110 that includes a radiotelephone. As illustrated, UE 110 may include a microphone 340 (e.g., of input device 320) for entering audio information, a speaker 345 (e.g., of output device 325) for outputting audio information, a keypad 355 (e.g., of input device 320) for entering information or selecting functions, and a display 350 (e.g., of input device 320 and/or output device 325) for outputting visual information and/or inputting information, selecting functions, etc.

Although FIG. 3C illustrates an exemplary implementation of UE 110, in other implementations, UE 110 may include fewer, additional, or different exemplary components than those depicted in FIG. 3C.

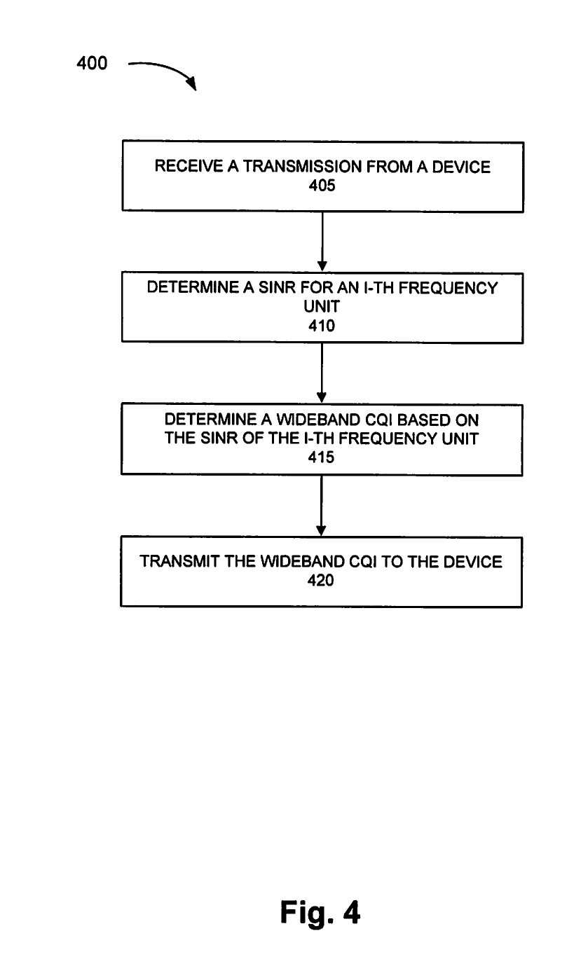

Described below, in connection with FIG. 4, are exemplary operations performed by wideband CQI calculator 335 to determine a wideband CQI(s). For purposes of discussion, the exemplary operations will be described based on communication system 100 depicted in FIG. 1B. However, it will be appreciated that the exemplary operations may be performed in communication system 100 depicted in FIG. 1A, in which different devices may be present. Based on the wideband CQI(s), wireless station may determine frequency selective SINR(s).

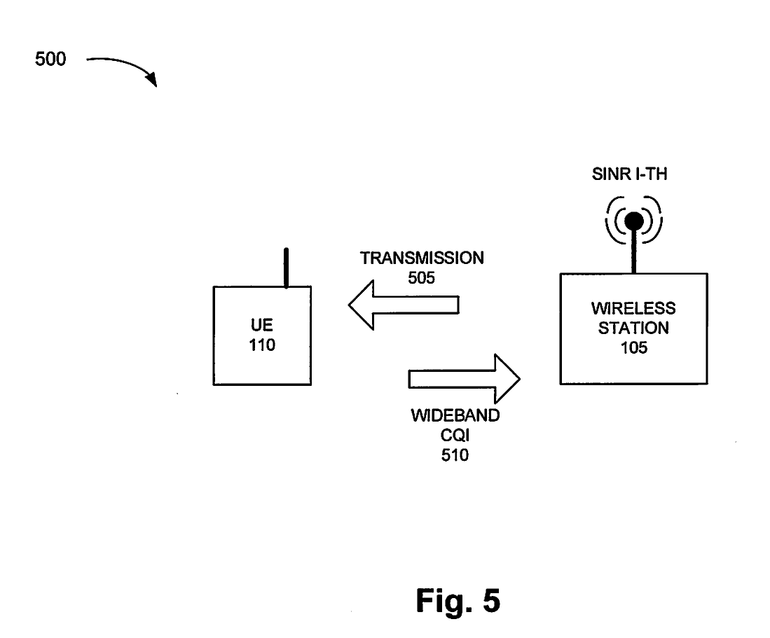

FIG. 4 is a flow diagram illustrating an exemplary process 400 that may be performed by UE 110 to calculate a wideband CQI. It will be appreciated that other methods, not specifically described, may be utilized to calculate the wideband CQI. In addition to FIG. 4, process 400 will be described in connection with FIG. 5. FIG. 5 is a diagram of an exemplary scenario 500 in which UE 110 may calculate the wideband CQI.

Process 400 may begin with receiving a transmission from a device (block 405). For example, as illustrated in FIG. 5, wireless station 105 may transmit a transmission 505 in the downlink (or forward channel) that is received by UE 110. Transmission 505 may include reference signals and/or may be transmitted on a pilot channel.

A SINR for an i-th frequency unit may be determined (block 410). In the frequency domain, the frequency spectrum may be divided into n frequency units. For example, in a OFDM communication system, the frequency spectrum may be divided into several sub-bands. A sub-band may include several frequency units (e.g., sub-carriers). In other communication systems, it will be appreciated that the frequency spectrum may be divided differently. In such instances, there may be a measured SINR value for at least one frequency unit, where the SINR for the i-th frequency unit is SINRᵢ. The definition of SINR is

$$SINR = \frac{C}{I} ,$$

where C represents the received signal power and I represents the interference plus noise power. The SINR value for the at least one frequency unit may be derived through known techniques (e.g., a conventional symbol level SINR estimation algorithm).

A wideband CQI based on the SINR of the frequency unit may be determined (block 415). Wideband CQI calculator 335 may determine a wideband CQI (CQI_{WB}), for example, by either linear average or non-linear average. Utilizing a linear averaging method, for example, the wideband CQI may be calculated based on the following exemplary expression:

$${CQI}_{WB} = Q \{ {\sum }_{i = 1}^{n} {SINR}_{i} / n \} \qquad ( 1 )$$

where Q { } represents a quantization function.

In another implementation, wideband CQI calculator 335 may determine a wideband CQI utilizing a non-linear method. In such instances, a symbol-level mutual information (SI) value may be calculated for the at least one i-th frequency unit (SIᵢ) based on the following exemplary expression:

SIᵢ=F{SINRᵢ} (2)

where F{ } represents the function on how to calculate modulated SI from SINR. The F{ } function is described by Lei wan et al., in “A Fading-Insensitive Performance Metric For A Unified Link Quality Model,” Wireless Communications and Network Conference 2006, Vol. 4, pgs. 2110-2114, which is incorporated herein by reference.

Next, an average SI (SI_{avg}) may be calculated based on the following exemplary expression:

$${SI}_{avg} = {\sum }_{i = 1}^{n} {SI}_{i} / n \qquad ( 3 )$$

The wideband CQI may then be calculated based on the following exemplary expression:

CQI_{WB}=Q{F⁻¹(SI_{avg})} (4)

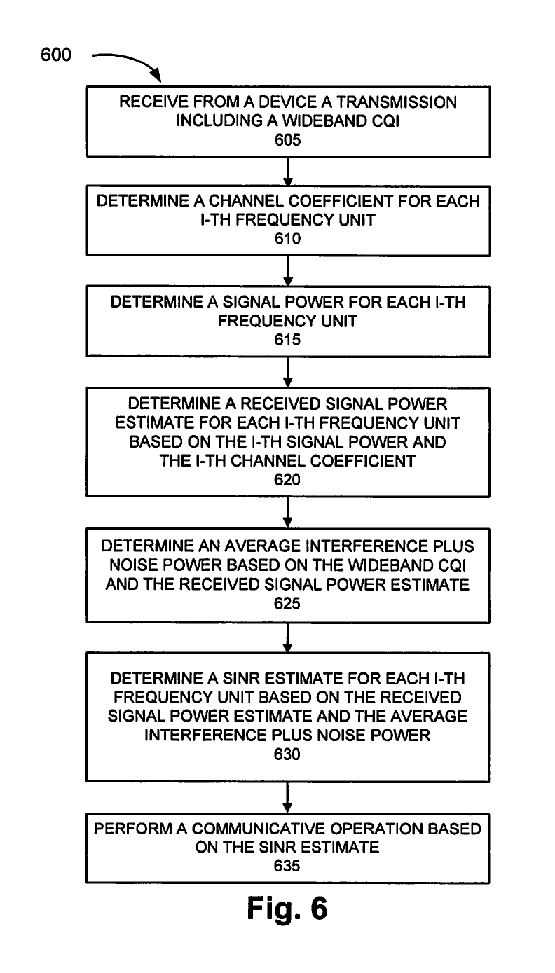

The wideband CQI may be transmitted to the device (block 420). For example, as illustrated in FIG. 5, UE 110 may transmit the wideband CQI to wireless station 105. Wireless station 105 may receive the wideband CQI and calculate a frequency selective SINR, as described in greater detail below in connection with FIG. 6.

Although FIG. 4 illustrates an exemplary process 400 for determining a wideband CQI, in other implementations, exemplary process 400 may include additional, different, and/or fewer operations than those described in connection with FIG. 4. For example, in other embodiments, UE 110 may employ a different measuring and reporting scheme. In one approach, UE 110 may measure C and I separately for the frequency units in the downlink. Correspondingly, UE 110 may generate a wideband C and a wideband 1. UE 110 may report the generated wideband C and I separately to wireless station 105 or report C/I as a wideband CQI to wireless station 105.

As previously described, in a TDD system, channel reciprocity exists. Based on channel reciprocity and the receipt of a wideband CQI, wireless station 105 may estimate a SINR for the i-th frequency unit. An exemplary process in which wireless station 105 calculates the estimated SINR for the i-th frequency unit is described below.

FIG. 6 is a flow diagram illustrating an exemplary process 600 that may be performed by wireless station 105 for determining the SINR for an i-th frequency unit.

Process 600 may begin with receiving a transmission including a wideband CQI (block 605). For example, UE 105 may transmit a wideband CQI to wireless station 105, as previously described in connection with block 420 of FIG. 4.

A channel coefficient for each i-th frequency unit may be determined (block 610). Based on channel reciprocity, SINR I-th FBE 220 may calculate a channel coefficient H for each i-th frequency unit (Hᵢ). For example, the channel coefficient H may be estimated based on reference signals (e.g., sounding signals or pilots) or other types of UL transmissions.

A signal power for each i-th frequency unit may be determined (block 615). Wireless station 105 has knowledge of the transmitted signal power (Sᵢ) for each i-th frequency unit on the downlink when the wideband CQI was determined at UE 110.

A received signal power estimate for each i-th frequency unit may be determined based on the i-th signal power and the i-th channel coefficient (block 620). SINR I-th FBE 220 may calculate an estimated received signal power (Cestᵢ) based on the following exemplary expression:

Cestᵢ=Sᵢ∥Hᵢ∥² (6)

An average interference-plus-noise power may be determined based on the wideband CQI and the estimated received signal power (block 625). SINR I-th FBE 220 may calculate an average interference-plus-noise power (I_{avg}) based on the following exemplary expression:

$${I}_{avg} = {\sum }_{i = 1}^{n} {Cest}_{i} / ( {nCQI}_{WB} ) \qquad ( 7 )$$

Although expression (7) represents a linear method approach to determine I_{avg}, in other implementations, I_{avg} may be determined based on a non-linear method approach. While it is recognized the interference may be colored in the frequency domain, it is assumed herein that the interference is flat in the frequency domain. Based on this assumption, an SINR estimate for the i-th frequency unit may be determined.

An SINR estimate for each i-th frequency unit may be determined based on the estimated received signal power and the average interference-plus-noise power (block 630). SINR I-th FBE 220 may calculate a SINR estimate for the i-th frequency unit based on the following exemplary expression:

SINR_estᵢ=Q{Cestᵢ/I_{avg}} (8)

where Q represents the quantization function. For example, a highest CQI threshold and a lowest CQI threshold may be provided, and an interval between them may be divided uniformly or non-uniformly into several scales. The CQI may be quantized as the highest scale that is among the scales that may be smaller than the CQI.

Alternatively, SINR I-th FBE 220 may calculate the SINR estimate for the i-th frequency unit based on the following exemplary expression:

$${SINR\_est}_{i} = Q \{ {CQI}_{WB} \frac{{S}_{i} {‖ {H}_{i} ‖}^{2}}{\frac{1}{n} {\sum }_{i = 1}^{n} {S}_{i} {‖ {H}_{i} ‖}^{2}} \} \qquad ( 9 )$$

A communicative operation may be performed based on the estimated SINR (block 635). Wireless station 105 may perform various communicative operations based on the SINR estimate. For example, wireless station 105 may perform link adaptation, scheduling, power control, timing control, modulation, beamforming, equalization, filtering, etc., with respect to UE 110.

Although, FIG. 6 illustrates an exemplary process 600 for determining a SINR estimate for the i-th frequency unit, in other implementations, exemplary process 600 may include additional, different, and/or fewer operations than those described in connection with FIG. 6. For example, although process 600 is described as determining a SINR estimate for each i-th frequency unit, process 600 may be implemented to determine a SINR estimate for less than each i-th frequency unit. Additionally, or alternatively, although process 600 has been described with respect to frequency units (e.g., sub-carriers), other bandwidths within the frequency domain may be contemplated (e.g., sub-bands).

As described herein, a device (e.g., a wireless station) may estimate a SINR at a finer frequency level or frequency band than a reported CQI (e.g., a wideband CQI). The SINR may be estimated with minimal overhead, yet improving the performance of link adaptation, scheduling, etc., as well as overall system performance, such as throughput, etc.

The term “frequency band,” may include, for example, one or more sub-carriers, one or more sub-bands, one or more frequency units, and/or some other frequency division of the wideband CQI. The term “wideband” may include the whole frequency domain or a portion of the whole frequency domain. Thus, depending on the bandwidth of the wideband CQI, the frequency band will be of a finer granularity. For example, if the wideband CQI corresponds to the whole frequency domain than the frequency band may correspond to, for example, one or more sub-bands or one or more sub-carriers. On the other hand, if the wideband CQI corresponds to a portion of the frequency domain, the frequency band may correspond to, for example, one or more sub-carriers. In this regard, it will be appreciated that the frequency band may be considered a frequency division of bandwidth with respect to the wideband CQI.

The foregoing description of implementations provides illustration, but is not intended to be exhaustive or to limit the implementations to the precise form disclosed. Modifications and variations are possible in light of the above teachings or may be acquired from practice of the teachings. For example, the concepts described herein may be implemented to generate CQI(s) outside a measurement bandwidth assuming interference does not vary significantly within the frequency domain. It is assumed that the interference I is measured in a bandwidth part which includes one or several sub-bands, and the interference in another sub-band i which is out of the bandwidth part does not vary significantly from the measuring bandwidth. Then the received DL signal power of the sub-band i can be calculated based on expression (6), and the corresponding estimated SINR for sub-band i may be determined based on the following exemplary expression:

$$SINR {est}_{i} = Q \{ \frac{{S}_{i} {‖ {H}_{i} ‖}^{2}}{I} \} \qquad ( 10 )$$

In addition, while a series of blocks has been described with regard to the processes illustrated in FIGS. 4 and 6, the order of the blocks may be modified in other implementations. Further, non-dependent blocks may be performed in parallel. Further one or more blocks may be omitted. It will be appreciated that one or more of the processes described herein may be implemented as a computer program. The computer program may be stored on a computer-readable medium or represented in some other type of medium (e.g., a transmission medium).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

It should be emphasized that the term “comprises” or “comprising” when used in the specification is taken to specify the presence of stated features, integers, steps, or components but does not preclude the presence or addition of one or more other features, integers, steps, components, or groups thereof.

No element, act, or instruction used in the present application should be construed as critical or essential to the implementations described herein unless explicitly described as such.

The term “may” is used throughout this application and is intended to be interpreted, for example, as “having the potential to,” configured to,” or “capable of,” and not in a mandatory sense (e.g., as “must”). The terms “a” and “an” are intended to be interpreted to include, for example, one or more items. Where only one item is intended, the term “one” or similar language is used. Further, the phrase “based on” is intended to be interpreted to mean, for example, “based, at least in part, on,” unless explicitly stated otherwise. The term “and/or” is intended to be interpreted to include any and all combinations of one or more of the associated list items.

1.-17. (canceled)

18. A method in a first device communicatively coupled to a second device in a wireless network, the method comprising:
receiving a first transmission that includes a wideband channel quality indicator associated with the second device;
determining a received signal power estimate for each frequency band of the first transmission based on the first transmission or for each frequency band of a second received transmission based on the received second transmission;
determining an average interference-plus-noise based on the wideband channel quality indicator and the received signal power estimate for each of the frequency bands;
determining a signal-to-interference-plus-noise-ratio estimate for each of the frequency bands based on the associated received signal power estimate and the average interference-plus-noise; and
transmitting a third transmission based on the signal-to-interference-plus-noise ratio estimate for each of the frequency bands.

19. The method of claim 18, further comprising:
performing at least one of link adaptation, scheduling, and another communicative operation based on the signal-to-interference-plus-noise ratio estimate for each of the frequency bands.

20. The method of claim 18, wherein the wireless network includes a time-division-duplex-based network, and each of the frequency bands corresponds to a frequency sub-carrier.

21. The method of claim 18, wherein determining the received signal power estimate for each frequency band comprises determining a transmitted signal power for each of the frequency bands.

22. The method of claim 18, further comprising:
determining a channel coefficient for each of the frequency bands; and
determining the received signal power estimate for each of the frequency bands based on the channel coefficient for each of the frequency bands.

23. The method of claim 18, wherein the first device includes a base station.

24. The method of claim 18, wherein the wideband channel quality indicator includes a value corresponding to a ratio of a received signal power and an interference-plus-noise power from a perspective of the second device.

25. The method of claim 18, wherein the wideband channel quality indicator includes a received signal power and an interference-plus-noise power from a perspective of the second device.

26. A device in a wireless environment, comprising:
at least one antenna; and
a processing system configured to:
receive, via the at least one antenna, a transmission that includes a wideband channel quality indicator associated with another device;
calculate a received signal power estimate for each frequency band of a frequency domain;
calculate an average interference-plus-noise based on the wideband channel quality indicator;
calculate a signal-to-interference-plus-noise estimate for each of the frequency bands; and
perform a communicative operation based on the signal-to-interference-plus-noise estimate for each of the frequency bands.

27. The device of claim 26, wherein the device includes a base station.

28. The device of claim 27, wherein the base station operates according to a time-division communication standard, and each of the frequency bands corresponds to a frequency sub-carrier.

29. The device of claim 26, wherein when calculating the average interference-plus-noise, the processing system is further configured to calculate the average interference-plus-noise based on the received signal power estimate for each of the frequency bands and the wideband channel quality indicator.

30. The device of claim 26, wherein when calculating the received signal power estimate, the processing system is further configured to:
calculate a transmitted signal power for each of the frequency bands; and
calculate a channel coefficient for each of the frequency bands.

31. The device of claim 30, wherein calculating the signal-to-interference-plus-noise estimate for each of the frequency bands is based on the transmitted signal power for each of the frequency bands and the channel coefficient for each of the frequency bands.

32. The device of claim 26, wherein calculating the signal-to-interference-plus-noise estimate for each of the frequency bands is based on a quantization of a ratio of the received signal power estimate for each of the frequency bands and the average interference-plus noise.

33. A computer-readable medium containing non-transitory instructions executable by at least one processor of a device capable of receiving and transmitting signals, the computer-readable medium comprising:
one or more instructions for receiving a transmission from another device, the transmission including a wideband channel quality indicator;
one or more instructions for calculating a received signal power estimate for each frequency band of a frequency domain;
one or more instructions for calculating an average interference-plus-noise of the frequency domain based on the wideband channel quality indicator and the received signal power estimate;
one or more instructions for calculating a signal-to-interference-plus-noise estimate for each of the frequency bands based on the average interference-plus-noise; and
one or more instructions for performing at least one of link adaptation, scheduling, and another communicative operation based on the calculated signal-to-interference-plus-noise estimate.

34. The computer-readable medium of claim 33, wherein the device is operable in a network having downlink and uplink reciprocity.
